(19) United States
(12) Patent Application Publication
(10) Pub. No.: US 2010/0014975 A1
(43) Pub. Date: Jan. 21, 2010

(54) Mast mounted heating system for a wind machine

(76) Inventor: Daryl G. Hill, Yakima, WA (US)

Correspondence Address: Svendsen Legal, LLC, P.O. Box 10627, Yakima, WA, 98909, US

(21) Appl. No.: 12/460,361

(22) Filed: Jul. 17, 2009

Related U.S. Application Data
(60) Provisional application No. 61/135,353, filed on Jul. 18, 2008.

(51) Int. Cl. F03D 11/00

(52) U.S. Cl. 416/95

(57) ABSTRACT

An air flow heating system for wind machine is provided, which can be mounted to a conventional, propeller driven wind machine's mast or tower, to provide a stream of heated updrafting air, for use by the wind machine, to supplement the overall convective air current in the vicinity of the wind machine. The system includes a heater assembly with a plurality of heater arms, each heater arm having at least a single burner, and each burner provided with a combustible fuel. The heater assembly mounts to the middle portion of the wind machine mast, below the propeller blade's rotation, thereby providing increased induced updraft and air mixing effects, while heating the air supplied to the propeller, without interfering with air flow to, or from the propeller, which is especially useful in freeze protection for crops and orchards

### TECHNICAL FIELD

An air flow heating system for a wind machine, which can be mounted to a conventional, propeller driven wind machine mast or tower, more specifically to provide a stream of heated updrafting air, for use by the wind machine, to supplement the overall convective air current in the vicinity of the wind machine.

### BACKGROUND OF THE INVENTION

Wind machines are increasingly employed for frost protection for agricultural applications, often to prevent springtime frost damage to a crop by forcing a localized circulation of air to a ground surface below the wind machine A conventional wind machine includes a tower or mast-mounted propeller, employed to mix the warmer air aloft, with cooler air that hugs the ground surface, as typically encountered during nighttime cooling. This air mixing serves to raise the temperature of a valued crop, located near to the ground surface, below.

Prior wind machine devices with heating features include U.S. Pat. No. 3,067,541 to Smith, and U.S. Pat. No. 3,296,739 to Wiegel. These heating devices supply a hot air stream for circulation by the propeller of the wind machine. However, these heaters would be difficult to retrofit to an existing wind-machine, and all fail to provide any additional air flow to the wind-machine, instead they obstruct the flow to or from the wind machine's propeller. A wind machine air flow heating system is needed that can be retrofit to an existing wind-machine, and beneficially supplements the air flow generated by the wind machine.

The following is a disclosure of the present invention that will be understood by reference to the following detailed description taken in conjunction with the accompanying drawings.

### BRIEF DESCRIPTION OF DRAWINGS

FIG. 1 is a side elevation view of a heating system for a wind machine, according to an embodiment of the invention;

FIG. 2 is a side elevation view of a portion of a heating system for a wind machine, according to an embodiment of the invention;

FIG. 3 is a perspective view of a portion a heating system for a wind machine, according to an embodiment of the invention; and

FIG. 4 is perspective view of a portion of a heating system, according to an embodiment of the invention.

Reference characters included in the above listed drawings indicate corresponding parts throughout the several view, as discussed herein. The description herein illustrates one preferred embodiment of the invention, in one form, and the description herein is not to be construed as limiting the scope of the invention in any manner. It should be understood that the above listed drawing figures are not necessarily to scale and that the embodiments are sometimes illustrated by fragmentary views, graphic symbols, diagrammatic or schematic representations, and phantom lines. Details that are not necessary for an understanding of the present invention by one skilled in the technology of the invention, or render other details difficult to perceive, may have been omitted.

### DETAILED DESCRIPTION OF SPECIFIC EMBODIMENTS

The present invention relates to a mast mounted heating system for a wind machine. The heating system can be mounted to a conventional wind machine mast or tower. The heating system serves to heat an airflow updraft, supplemental to the overall convective air current in the vicinity of the wind machine, thereby inducing a localized ground surface airflow, while warming the air circulated by the wind machine, without impeding the airflow to or from the propeller. The wind machines able to employ the present invention, are used to service orchards and crops, primarily for freeze protection.

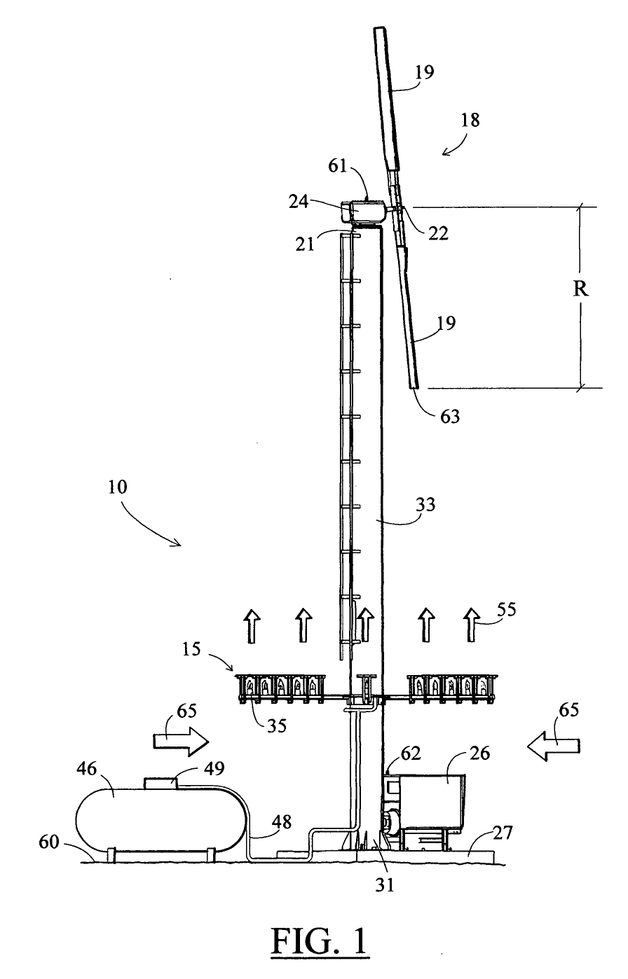

A preferred embodiment the mast mounted heating system, simply referred to herein as the ‘heating system,’ is shown in FIGS. 1 through 4. As shown in FIG. 1, the heating system 10 includes a heater assembly 15 mounted to a mast 16, which is the central tower of a conventional wind machine 17. These conventional types of wind machines all generate a wind stream. The wind stream is an air stream, typically generated by the rotation of a propeller 18. Most typically, the propeller has two propeller blades 19, each mounted opposed to the other. However, propellers with three, four or more blades can be employed. Alternatively, the wind machine can be any wind stream generating device known to those persons skilled in the design and use of such machines, such as a turbine fan, which could mount atop a mast to produce a directional stream of air in a sufficient quantity for the purposes of the present invention.

As preferred, the wind machine 17 has a propeller assembly 20 that includes propeller drive transmission 24, which is rotatably mounted proximate to a top end 21 of the mast 16. Specifically, the propeller 19 of the wind machine rotates on a hub 22, also referred to herein as a “rotatable hub.” The rotatable hub extends from the propeller drive transmission, which is set on or near the top end of the mast. Most preferably, the propeller drive transmission is of a conventional design that can swivel about the mast's vertical axis. The propeller drive assembly can be selectably directed about a radius of 360 degrees on the mast, by the swiveling rotation of the propeller drive transmission.

As also shown in FIG. 1, for this preferred embodiment, the propeller drive transmission is powered by a propeller drive motor 26, mounted to an anchor base 27 proximate to a ground surface 60. As typical, the drive motor rotates a drive shaft that runs internally the length of the mast 16 to the propeller drive transmission. The mast has a base end 31 opposite the top end, and a middle portion 33 located above the base end, and below the top end 21 of the mast. The base end of the mast mounts upon the anchor base, preferably proximate the propeller drive motor. The propeller drive motor is any conventional motor, and may be electrical, hydraulically powered or any such conventional automotive or equipment type of motor or generator. In the alternative, any means of transferring power to the propeller drive assembly is considered for use with the present invention, including propeller drive systems primarily located proximate to the top end of the mast.

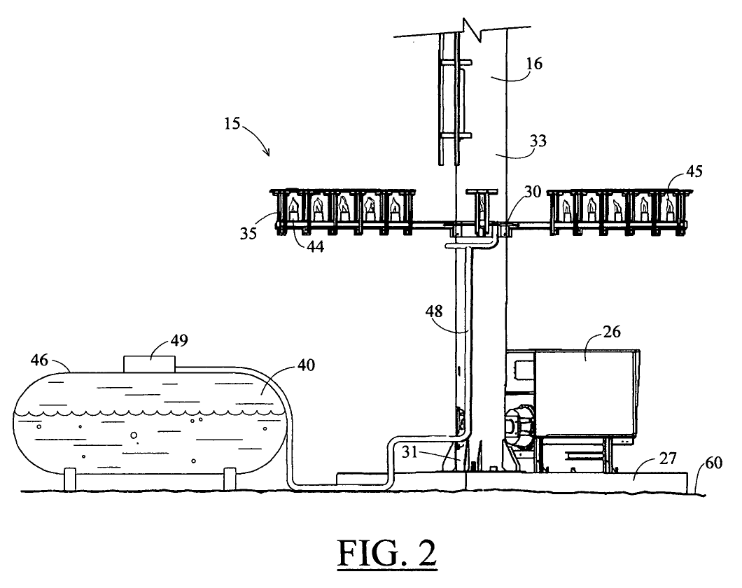

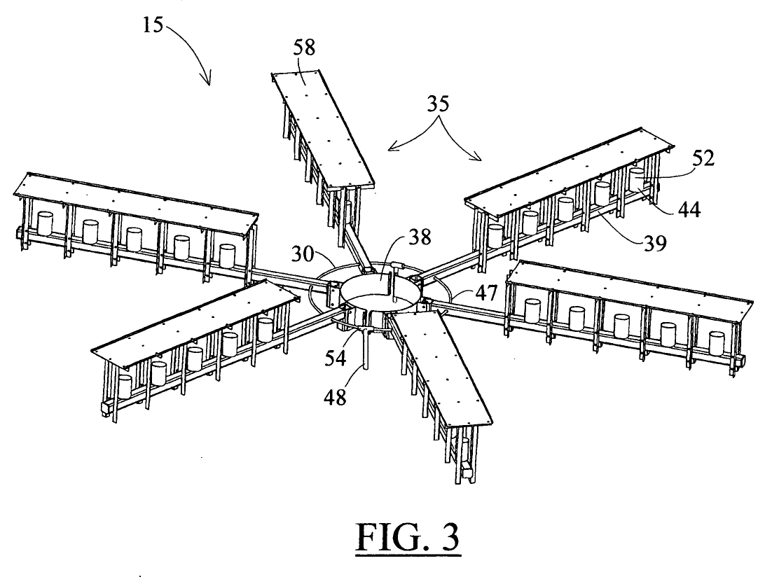

The heater assembly 15 mounts to the mast 16 as shown in FIG. 2, and includes a plurality of heater arms 35. The number of heater arms can vary greatly, depending on the heater assembly configuration selected, primarily for the desired heating effects. In a most preferred embodiment of heater assembly, as detailed in FIG. 3, the heater assembly includes four heater arms, each radiating from a collar 38. The heater arms are most preferably spaced at regular intervals, radially about the mast. This provides the same heating effect of the heating system 10 regardless of which direction the propeller drive assembly 20 points, from the rotation of the propeller drive transmission 24. As preferred, each heater arm is approximately six feet in length, but could be from four feet to ten feet, or any feasible length desired, as to achieve the functions herein described. Specifically, the term “approximately” is used herein to refer to a range of measurable values or relative orientations, understood by a person skilled in the pertinent field or skill, as being substantially equivalent to the herein stated values in achieving the desired results, a range typical to the accuracy and precision of conventional tooling, instrumentation or techniques, or a functionally equivalent range of features that produces equivalent results to those described herein.

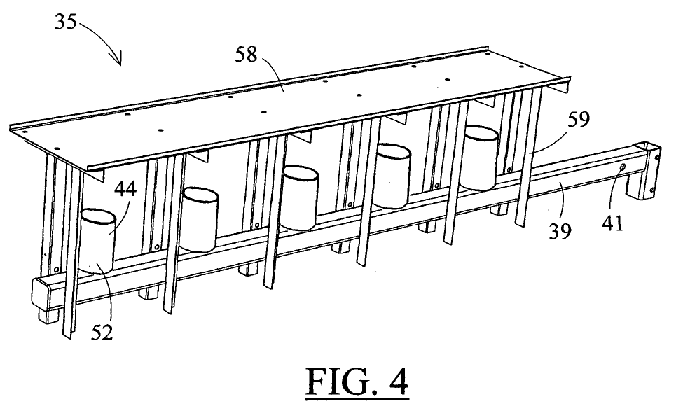

As shown in FIG. 3, each heater arm preferably includes a base tube 39, capped at each for receiving a combustible fuel 40 distributed to the heater arm from a manifold 30. Preferably, as detailed in FIG. 4, the combustible fuel is routed into the base tube through a base tube gas inlet 41. In the alternative, any conventional pipe or tubing suitable for supplying the selected combustible fuel to a burner 44 positioned on the heater arm 35, could be employed as or in addition to the base tube to route the combustible fuel along each heater arm.

Preferably, the combustible fuel 40 is a flow-able hydrocarbon rich substance, or any such conventional fossil or bio-fuel that can flow to the burner 44 under pressure from a fuel source or storage located externally from the heater assembly. Most preferably, the combustible fuel is a methane, as found in conventional natural gas, as typically piped from a local utility, or a propane as typically stored in a pressurized liquid state on site, in a tank 46, as shown in FIGS. 1 and 2. A butane, a benzene, a gasoline, a kerosene, an alcohol, or any mixture or derivative thereof, can be included as a component of the combustible fuel. Additionally, the combustible fuel can be any conventional fuel substance as known by those skilled in combustible fuel selection, for use with heaters.

As shown in FIG. 2, the combustible fuel 40 is preferably received into the manifold 30, which is most preferably a circular distribution manifold 47, by way of a supply fuel line 48. For the preferred liquefied propane fuel, a regulator and control valve 49 are employed to flash the pressurized liquid propane stored in the tank 46, to a gas at a constant pressure and flow rate, suitable for use by the burners 44 of the heater assembly 15. The burner 44 maybe a series of burners placed in any desired array on the heater arms 35. Multiple burners are preferred, with five burners positioned on each of four heater arms being most preferred, as shown in FIG. 3, and detailed in FIG. 4. The burners are preferably conventional gaseous fuel types of a torch head 52, with typical, gas metering orifice nozzles near the bottom of each torch head. The design and selection of torch heads are well known to those skilled this area of heating technology. Conventionally, the nozzles within each torch head attach to the supply of combustible fuel 40 by a threaded connection, in this instance to the base tube 39 of the heater arm. This nozzle connection serves to inject the fuel into the burner, where it instantaneously mixes with air rising into the torch head, becoming ideally suitable for combustion. A combustion flame 45 is shown in FIGS. 1 and 2. Any conventional ignition system could be employed to initiate and maintain the firing of the burners, such as manual firing, pilot flame systems, electric spark plugs, solid-state ignitions, or piezoelectric spark systems, all of which are well known to those persons skilled in this technology.

As shown in FIG. 3, the circular distribution manifold 47 receives the combustible fuel 40 from the supply fuel line 48, and through a manifold fuel inlet 54. The circular distribution manifold includes a pipe ringing the mast 16, near the collar 38 of the heater assembly 15, and connecting to each base tube 39 of each heater arm 35. With the circular distribution manifold filled and pressurized with the combustible fuel. The fuel then throttles into the burners to combust and heat the surrounding air, creating a heated air updraft 55, as shown in FIG. 1.

Most preferably, to aid in the diffusion of the combustion flame 45 from the burners 44 and protect the burners from snow and rain, deflectors 58 are mounted to each base tube 39 of each heater arm 35, as shown in FIGS. 1 through 4. As detailed in FIG. 4, each deflector mounts on a defector post 59, attached to the base tube, below. The deflectors are most preferably formed of an aluminum, or other heat resistant metal alloy.

As shown in FIG. 1, each propeller blade 19 of the propeller 18 has an outer tip 63, the outer tip located on the propeller blade at a point furthest from the rotatable hub 22 of the propeller drive assembly 20. The propeller has a blade radius R, measured from the rotatable hub to the outer tip of the propeller blade. Again, any type of propeller blade could conform to this measurement, with the outer tip generally defined at a point on the blade or rotating blade structure furthest in a radial line from the rotatable hub. An important feature of the heater assembly 15 is the heater arms 35 of the heater assembly are mounted beyond the reach of the propeller blades, or further than approximately the blade radius, downward toward the ground surface 60 from the top end 21 of the mast 16. With the heater assembly mounted to the middle portion 33 of the mast, and below the blade radius from the rotatable hub of the propeller assembly as discussed above, the heater assembly avoids restrictive reduction or disruption of the air flow to and from the propeller. With the anchor base 27 embedded proximate to the ground surface, and the heater assembly positioned approximately more than six feet above the ground surface, as shown in FIG. 1, the heater assembly is well below the propeller.

A significant advantage of the heating system 10 is realized from the heated air updraft 55 generated by the combustion flame 45 from the burners 44. This heated air updraft beneficially supplements the overall convective air currents in the vicinity of the wind machine 17. This supplementing airflow induces a localized ground surface airflow 65 toward the wind machine, as shown in FIG. 1, while warming the air circulated by the wind machine, and again without impeding the airflow to or from the propeller 18. Positioning the heater assembly at approximately more than six feet above the ground surface allows for adequate clearance for formation of the localized ground surface airflow, and reduces the possible overhead clearance hazard for persons on the ground surface.

As a preferred alternative, the heating system 10 of the present invention is utilized in agricultural heating and freeze protection applications. In such an embodiment, the target of the heated air updraft 55 is an orchard or crop growing area. Other applications for the heater apparatus are considered wherever a heated airstream needs to be supplied to a rotatable air moving device, such as the wind machine 17, and especially when it is undesirable to place the heater directly in front of or behind the propeller 18. The heated air updraft from the mast mounted heating system can be directed toward a variety of general or specific targets. These targets can include orchards, vineyards, crops or any other areas that require the heating and air movement effects of a type that can be provided by the system of the present invention.

Operational control of the heating system 10, beyond the regulator and control valve 49, is preferably achieved through the use of temperature sensors located above and below the heater assembly 15, as shown in FIG. 1. A top sensor 61 can be positioned proximate the top end 21 of the mast 16 to monitor an updraft temperature, in concert with a base sensor 62 positioned proximate to the base end 31 of the mast, below the heater assembly, to monitor a ground layer temperature. Operation of the heating system can be initiated when the ground layer reaches a critically low temperature. The increase in temperature difference between the top sensor and the base sensor can also be monitored, with the flow of combustible fuel 40 increased or decreased to affect the temperature difference, as desired. Any operational system, as employed by those persons skilled in the field of automated orchard heating technologies could be utilized to operate the heating system.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. A heating system for a wind machine comprising:
a mast having a base end, a middle portion and a top end, the base end mounted upon a anchor base, the middle portion located above the base end and below the top end of the mast, and a rotatable hub proximate to the top end of the mast;
a propeller assembly including a propeller blade mounted to the rotatable hub, the propeller blade rotatable in a propeller radius about the rotatable hub;
a heater assembly including a plurality of heater arms, each heater arm having at least a single burner, and each burner supplied with a combustible fuel; and
the heater assembly mounted to the middle portion of the mast, beyond the propeller radius.

2. The heating system of claim 1, wherein:
the anchor base is embedded proximate to a ground surface, and the heater assembly is positioned on the mast at a height of more than six feet above the ground surface.

3. The heating system of claim 1, wherein:
the anchor base is embedded proximate to a ground surface, and the heater assembly is positioned on the mast at a height above the ground surface to allow for formation of a localized ground surface airflow from below the heater assembly.

4. The heating system of claim 1, wherein the combustible fuel is a flow-able hydrocarbon rich substance, provided to the burner under pressure from a fuel source located external from the heater assembly.

5. The heating system of claim 1, wherein the combustible fuel includes components selected from the group consisting of: a methane, a natural gas, a propane, a butane, a benzene, a gasoline, a kerosene, and an alcohol.

6. The heating system of claim 1, wherein the burner is a plurality of torch heads located on each heater arm.

7. A heating system for a wind machine comprising:
a mast having a base end, a middle portion and a top end, the base end mounted upon a anchor base, and the middle portion located above the base end and below the top end of the mast;
a propeller assembly including a propeller blade mounted to a hub, the propeller blade having an outer tip, the outer tip located on the propeller blade at a point furthest from the hub, and the propeller blade rotatable on the hub;
the propeller blade having a blade radius measured from the hub to the outer tip of the propeller blade;
a heater assembly including a plurality of heater arms, each heater arm having at least a single burner, and each burner provided with a combustible fuel; and
the heater assembly mounted to the middle portion of the mast, below the blade radius from the hub of the propeller assembly.

8. The heating system of claim 7, wherein:
the anchor base is embedded proximate to a ground surface, and the heater assembly is positioned on the mast at a height of more than six feet above the ground surface.

9. The heating system of claim 7, wherein:
the anchor base is embedded proximate to a ground surface, and the heater assembly is positioned on the mast at a height above the ground surface to induce a localized ground surface airflow from below the heater assembly.

10. The heating system of claim 7, wherein the combustible fuel is a flow-able hydrocarbon rich substance, provided to the burner under pressure from a fuel source located external from the heater assembly.

11. The heating system of claim 7, wherein the combustible fuel includes components selected from the group consisting of: a methane, a natural gas, a propane, a butane, a benzene, a gasoline, a kerosene, and an alcohol.

12. The heating system of claim 7, wherein the burner is a plurality of torch heads located on each heater arm.

13. A heating system for a wind machine comprising:
a mast having a base ends a middle portion and a top end, the base end mounted upon a anchor base, and the middle portion located above the base end and below the top end of the mast;
a propeller mounted to a hub, the propeller having an outer tip, the outer tip located on the propeller at a point furthest from the hub, and the propeller rotatable about the hub;
the propeller having a blade radius measured from the hub to the outer tip of the propeller;
a heater assembly including a plurality of heater arms, each heater arm having at least a single burner, and each burner provided with a combustible fuel; and
the heater assembly mounted to the middle portion of the mast, below the blade radius from the hub of the propeller.

14. The heating system of claim 13, wherein:
the anchor base is embedded proximate to a ground surface, and the heater assembly is positioned on the mast at a height of more than six feet above the ground surface.

15. The heating system of claim 13, wherein:
the anchor base is embedded proximate to a ground surface, and the heater assembly is positioned on the mast at a height above the ground surface to induce a localized ground surface airflow into the heater assembly from below the heater assembly.

16. The heating system of claim 13, wherein the combustible fuel is a flow-able hydrocarbon rich substance, provided to the burner under pressure from a fuel source located external from the heater assembly.

17. The heating system of claim 13, wherein the combustible fuel includes components selected from the group consisting of: a methane, a natural gas, a propane, a butane, a benzene, a gasoline, a kerosene, and an alcohol.

18. The heating system of claim 13, wherein the burner is a plurality of torch heads located on each heater arm.
